(19) United States
(12) Patent Application Publication
(10) Pub. No.: US 2017/0030574 A1
(43) Pub. Date: Feb. 2, 2017

(54) CANDLE HOLDER LINER KIT

(71) Applicant: TAMARA M. BROWN, Stittsville (CA)

(72) Inventor: TAMARA M. BROWN, Stittsville (CA)

(21) Appl. No.: 14/813,238

(22) Filed: Jul. 30, 2015

(51) Int. Cl. F21V 35/00; F23D 3/16

(52) U.S. Cl. CPC F21V 35/00; F23D 3/16

(57) ABSTRACT

A candle holder liner kit can include at least one liner, at least one filament, and a container. The at least one liner can be flexible and extend a width between opposite lateral sides. The at least one liner can be configured to wrap around a body of a candle. The at least one filament can be flexible and extend a length between at least first and second ends. The at least one filament can be configured to be positioned between the at least one liner and a candle holder. The length can be greater than the width. The at least one liner and the at least one filament can be disposed in the container.

### BACKGROUND

1. Field

The present disclosure relates to a drip guard for a candle.

2. Description of Related Prior Art

U.S. Pub. No. 2007/0207428 discloses a CANDLE DRIP GUARD. The drip guard is for use with a candle made of flexible material such as aluminum foil which is cut into a fan shape. The drip guard may be formed into a cone or other shape by bending or folding the fan radially. The opening has slits and tabs that allow a candle to pass through while still holding the candle snugly within the opening. Once rolled or folded the flexible material is overlapped upon itself. Perforations may be provided in the flexible material to allow light from the candle to pass through. A canopy may be provided for the drip guard to shield the candle from weather.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A candle holder liner kit can include at least one liner, at least one filament, and a container. The at least one liner can be flexible and extend a width between opposite lateral sides. The at least one liner can be configured to wrap around a body of a candle. The at least one filament can be flexible and extend a length between at least first and second ends. The at least one filament can be configured to be positioned between the at least one liner and a candle holder. The length can be greater than the width. The at least one liner and the at least one filament can be disposed in the container.

### BRIEF DESCRIPTION OF THE DRAWINGS

The detailed description set forth below references the following drawings:

FIG. 1 is a perspective view of an exemplary embodiment of a kit according to an exemplary embodiment of the present disclosure in a pre-assembled condition; and

FIG. 2 is an exploded view of an exemplary embodiment of a kit according to an exemplary embodiment of the present disclosure relative to an assembled condition.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

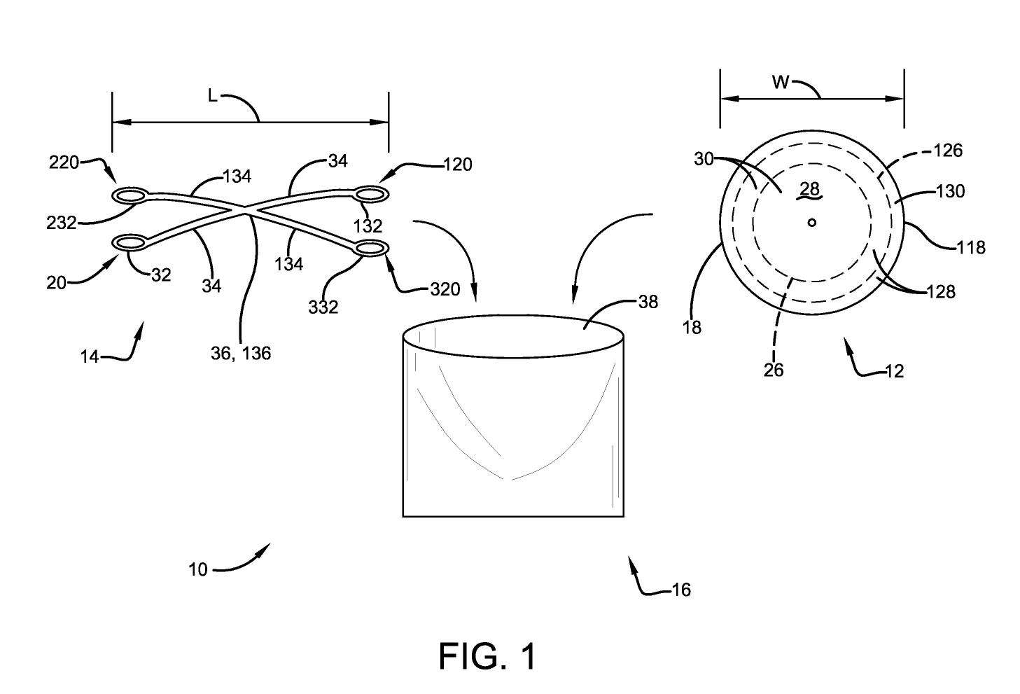

Referring now to FIG. 1, a candle holder liner kit 10 can include at least one liner 12, at least one filament 14, and a container 16. The at least one liner 12 can be flexible and extend a width W between opposite lateral sides 18, 118. The at least one liner 12 can be configured to wrap around a body of a candle. The at least one filament 14 can be flexible and extend a length L between at least first and second ends 20, 120. The at least one filament 14 can be configured to be positioned between the at least one liner 12 and a candle holder. The at least one filament 14 can have a length L greater than the width W of the at least one liner 12. The at least one liner 12 and the at least one filament 14 can be disposed in the container 16.

The at least one liner 12 can be formed from foil. Foil can be desirable in that a foil liner 12 can be bent around the edges of a candle holder to inhibit wax from flowing between the liner 12 and the candle holder. The foil can by non-flammable. Ultima-foil from RadiantGUARD® is one kind of foil that can be used in one or more embodiments of the present disclosure. Other kinds of non-flammable, sheet material can be applied in one or more embodiments of the present disclosure.

The at least one liner 12 can have a circular perimeter. In other embodiments, the perimeter of the liner 12 can be non-circular. The opposite lateral sides 18, 118 can be defined as points along the exemplary circular perimeter of the liner 12 and be one hundred and eighty degrees apart.

The at least one liner 12 can include at least one score line dividing the liner 12 into at least two separable sections. This allows the liner 12 to be adjustable in size to accommodate candle holders having different depths and/or different aperture diameters. In the exemplary embodiment, the liner 12 includes a plurality of concentric score lines 26, 126. The liner 12 can be divided into a first section 28 and a second section 128 when divided along the score line 26. The liner 12 can be divided into a first section 30 and a second section 130 when divided along the score line 126.

The at least one filament 14 can be metallic. A metallic filament 14 can retain a bent shape and can be bent around the opening of candle holder to be relatively flush with the candle holder. Any kind of metal can be applied to form the filament 14 in various embodiments of the present disclosure. Further, materials other than metal can be utilized to form the filament 14 in various embodiments of the present disclosure.

The at least one filament 14 can include a first loop 32 positioned at the first end 20. The at least one filament 14 can also include a second loop 132 positioned at the second end 120. The loops 32, 132 can be utilized to draw the liner 12 out of a candle holder after a candle has been consumed.

The exemplary filament 14 can be x-shaped. The exemplary filament 14 can extend in a first strand 34 between the first and second ends 20, 120 and in a second strand 134 between a third end 220 and a fourth end 320. Loops 232, 332 can be disposed at the third end 220 and the fourth end 320, respectively. The first and second strands 34, 134 can extend transverse to one another and be interconnected at a midpoint 36 of the first strand 34 and a midpoint 136 of the second strand 134. The filament 14 can be as thin as possible in order to allow a candle to sit flush enough against the bottom surface of the candle holder when inserted into the candle holder that the candle is stable. Further, some candles may be sufficiently deformable to be pressed and deformed around the filament 14. In such a situation, at least a portion of the candle can be flush with the bottom surface of the candle holder aperture.

The container 16 can be a clear, flexible bag in one or more embodiments of the present disclosure. In one or more embodiments, a rigid container can be utilized and/or an opaque container. The liner 12 and the filament 14 can be inserted in the container 16 through an opening 38 of the container 16. After the liner 12 and the filament 14 are inserted in the container 16, the opening 38 can be closed. A purchaser of the kit 10 can open the closed container 16 to remove the liner 12 and the filament 14.

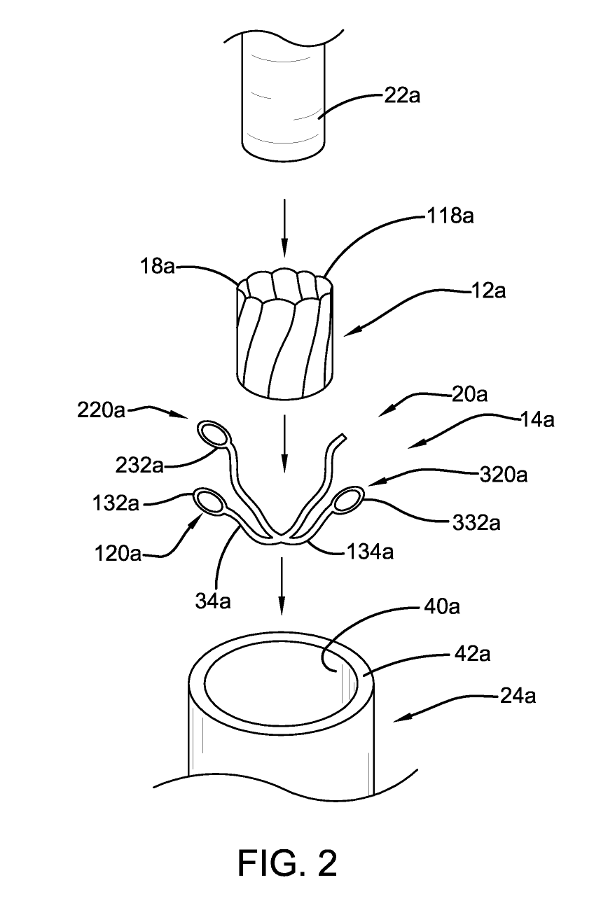

Referring now to FIG. 2, in another embodiment of the present disclosure, a candle holder liner kit can include at least one liner 12a, at least one filament 14a, and a container (not shown in FIG. 2). The at least one liner 12a can be flexible and extend a width between opposite lateral sides 18a, 118a. The at least one liner 12a can be configured to wrap around a body of a candle 22a. The at least one filament 14a can be flexible and extend a length between at least first and second ends 20a, 120a. The at least one filament 14a can be configured to be positioned between the at least one liner 12a and a candle holder 24a. The length of the at least one filament 14a can be greater than the width of the at least one liner 12a. The at least one liner 12a and the at least one filament 14a can be disposed in the container.

In one example of operation, a user can acquire the kit, open the container and remove the liner 12a and the filament 14a. The liner 12a can be wrapped around the candle 22a. The filament 14a can then be wrapped around the liner 12a.

The exemplary filament 14a can be x-shaped. The exemplary filament 14a can extend in a first strand 34a between the first and second ends 20a, 120a and in a second strand 134a between a third end 220a and a fourth end 320a. Loops 132a, 232a, 332a can be disposed at the second end 120a, the third end 220a, and the fourth end 320a, respectively. The first end 20a can be without a loop.

After the liner 12a is wrapped around the candle 22a and the filament 14a is wrapped around the liner 12a, the candle 22a, liner 12a, and filament 14a can be inserted in an aperture 40a of the candle holder 24a. The portion of the liner 12a protruding above the aperture 40a can be trimmed (such as through score lines) and/or folded over the top surface 42a of the candle holder 24a. The portion of the filament 14a protruding above the aperture 40a can be folded over the top surface 42a of the candle holder 24a. The candle 22a can then be lit.

After candle 22a has been consumed, the ends 20a, 120a, 220a, and 320a can be grasped and pulled to draw the liner 12a out of the aperture 40a. The end 20a can be easily strung through the loops 132a, 232a, and 232a so that only the end 20a need be pulled by the user. The liner 12a, containing any remaining wax, can thus be drawn out of the aperture 40a, leaving the candle holder 24a clean and able to accept another candle.

Referring again to FIG. 1, in one or more embodiments of the present disclosure, the at least one liner 12 can be defined as a plurality of liners 12 of a first quantity. The at least one filament 14 can be defined as a plurality of filaments 14 of a second quantity. The first quantity can be greater than the second quantity. For example, the container 16 can include ten liners 12 and five filaments 14. In various embodiments, any number of liners 12 and any number of filaments 14 can be held within the container 16.

In one or more embodiments of the present disclosure, the at least one liner 12 can be defined as a plurality of liners 12. The at least one filament 14 can be defined as a single filament 14. For example, the container 16 can include ten liners 12 and one filament 14.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A candle holder liner kit comprising:
at least one liner being flexible and extending a width between opposite lateral sides, said at least one liner configured to wrap around a body of a candle;
at least one filament being flexible and extending a length between at least first and second ends, said at least one filament configured to be positioned between said at least one liner and a candle holder, said length greater than said width; and
a container wherein said at least one liner and said at least one filament are disposed in said container.

2. The candle holder liner kit of claim 1 wherein said at least one liner is further defined as formed from foil.

3. The candle holder liner kit of claim 1 wherein said at least one liner is further defined as having a circular perimeter and said opposite lateral sides are further defined as points along said circular perimeter one hundred and eighty degrees apart.

4. The candle holder liner kit of claim 1 wherein said at least one liner is further comprises:
at least one score line dividing said at least one liner into at least two separable sections.

5. The candle holder liner kit of claim 4 wherein said at least one score line is further defined as a plurality of score lines.

6. The candle holder liner kit of claim 5 wherein said plurality of score lines are concentric.

7. The candle holder liner kit of claim 1 wherein said at least one filament is further defined as metallic.

8. The candle holder liner kit of claim 1 wherein said at least one filament further comprises:
a first loop positioned at said first end; and
a second loop positioned at said second end.

9. The candle holder liner kit of claim 1 wherein said at least one filament is further defined as x-shaped, extending in a first strand between said first and second ends and in a second strand between a third end and a fourth end.

10. The candle holder liner kit of claim 9 wherein said first and second strands extend transverse to one another.

11. The candle holder liner kit of claim 9 wherein said first and second strands are interconnected at a midpoint of said first strand and a midpoint of said second strand.

12. The candle holder liner kit of claim 9 wherein said at least one filament further comprises loops at each of said first end, said second, said third end, and said fourth end.

13. The candle holder liner kit of claim 9 wherein said at least one filament further comprises loops at less than all of said first end, said second, said third end, and said fourth end.

14. The candle holder liner kit of claim 1 wherein:
said at least one liner is further defined as a plurality of liners of a first quantity;
said at least one filament is further defined as a plurality of filaments of a second quantity; and
said first quantity being greater than said second quantity.

15. The candle holder liner kit of claim 1 wherein:
said at least one liner is further defined as a plurality of liners; and
said at least one filament is further defined as a single filament.
